(19) United States
(12) Patent Application Publication
(10) Pub. No.: US 2012/0172121 A1
(43) Pub. Date: Jul. 5, 2012

(54) Music Game System Capable Of Text Output And Computer-Readable Storage Medium Storing Computer Program Of Same

(76) Inventor: Osamu Migitera, Minato-ku (JP)

(21) Appl. No.: 13/395,043

(22) PCT Filed: Sep. 7, 2010
(86) PCT No.: PCT/JP2010/065336

§ 371 Date: Mar. 8, 2012

(30) Foreign Application Priority Data
Sep. 11, 2009 (JP) 2009-210565
Sep. 11, 2009 (JP) 2009-210573

(51) Int. Cl. A63F 13/00

(52) U.S. Cl. 463/31

(57) ABSTRACT

Provided is a music game system whereby the degree of freedom with respect to the correlation between lyrics and an indication of operation is provided. The system determines, based on the sequence data, an operation timing within a predetermined time range from the current moment in music piece toward the future, and moves the object corresponding to each operation timing determined so as to coincide with the operation reference mark at the operation timing which should be indicated by the object. The lyrics data describes a text of lyrics to be outputted in accordance with the music piece. The system also determines the text to be assigned to each object based on each operation timing in the sequence data and the moment in music piece correlated to each text in the lyrics data and displays the text assigned to the object as a part thereof.

### TECHNICAL FIELD

The present invention relates to a music game system and the like which are capable of outputting texts of lyrics in addition to providing an operation guide for a player.

### BACKGROUND ART

As a music game system capable of outputting (displaying, or reproducing) text of lyrics and displaying a guide of operation according to music reproduction, proposed is a music game system in which the text of lyrics and indications of operations are correlated to each other by assigning a numeral value to each Japanese character (hereinafter referred to as a “character”) included in lyrics using a numeral value table, generating a command for specifying an operation portion of an input device is generated in a unit of more than one character based on the numeral values, and displaying operation indication marks being scrolled in a game image by following the commands (for example, see Patent Literature 1). In addition, there is Patent Literature 2 as a prior art literature relating to the present invention.
Patent Literature: PTL 1: 2005-46446 and PTL 2: 2005-46445.

### SUMMARY OF INVENTION

### Problem to be Solved by Invention

In the game system disclosed in Patent literature 1, the numeral number is assigned uniquely to the text included in the lyrics, and the kind of operation indication mark is determined based on the numeral value. Thereby, some limitations exist with respect to the correlation between the text included in the lyrics and the indications. For example, in order to change the correlation between the text and the operation indications, the data itself of a numeral value table, which is a basis for assigning the numeral values, has to be changed. As long as the data of numeral value table is the same data, even if different music is reproduced, when the lyrics are the same text, the same operations are indicated.

Then, the present invention aims to provide a music game system and the like, which is capable of improving the degree of freedom with respect to the correlation between the text of lyrics and the indication of operation.

### Solution to Problem

The game system as one aspect of the present invention is configured as the following. A music game system capable of text output comprises: an input device having at least one operation portion; a display device which displays a game image; a sound output device which reproduces a game sound; a music-piece data memory device which stores music piece data for reproducing a music piece; a music piece reproduction device which reproduces the music piece from the sound output device based on the music piece data; a sequence data memory device which stores sequence data where an operation timing of the operation portion during a reproduction of the music piece is described; an operation instruction device which determines based on the sequence data the operation timing of the operation portion included in a predetermined time range from a current moment in music piece toward a future, and instructs a player an operation of the operation portion by displaying an operation indication mark corresponding to each operation timing determined and an operation reference mark corresponding the current moment in such a manner that the operation indication mark and the operation reference mark are arranged along with a temporal axis in the game image, and making a comparative disposition between the operation reference mark and the operation indication mark according to temporal progress in the music piece so as to coincide the operation indication mark with the operation reference mark at the operation timing to be indicated by the operation indication mark; a text data memory device which stores, as data different from the sequence data, text data where a text to be outputted according to the music piece is correlated to a moment in music piece; a text assignment determination device which determines the text which should be assigned to each of the operation indication marks based on each of the operation timings on the sequence data and the moment of music piece corresponding to the text in the text data; and a text output device which outputs the text assigned by the text assignment determination device in association with an instruction of each operation timing by the operation indication mark.

Also, a computer program for a music game system stored in a computer readable storage medium of as one aspect of the present invention is configured as the following. A computer readable storage medium stores a computer program for a music game system. the music game system comprises an input device having at least one operation portion; a display device which displays a game image; a sound output device which reproduces a game sound; a music-piece data memory device which stores music piece data for reproducing a music piece; a music piece reproduction device which reproduces the music piece from the sound output device based on the music piece data; a sequence data memory device which stores sequence data where an operation timing of the operation portion during a reproduction of the music piece is described; and a text data memory device which stores, as data different from the sequence data, text data where a text to be outputted according to the music piece is correlated to a moment in music piece, and the computer program makes a computer incorporated in the music game system function as: an operation instruction device which determines based on the sequence data the operation timing of the operation portion included in a predetermined time range from a current moment in music piece toward a future, and instructs a player an operation of the operation portion by displaying an operation indication mark corresponding to each operation timing determined and an operation reference mark corresponding the current moment in such a manner that the operation indication mark and the operation reference mark are arranged along with a temporal axis in the game image, and making a comparative disposition between the operation reference mark and the operation indication mark according to temporal progress in the music piece so as to coincide the operation indication mark with the operation reference mark at the operation timing to be indicated by the operation indication mark; a text assignment determination device which determines the text which should be assigned to each of the operation indication marks based on each of the operation timings on the sequence data and the moment of music piece corresponding to the text in the text data; and a text output device which outputs the text assigned by the text assignment determination device in association with an instruction of each operation timing by the operation indication mark.

According to the present invention, when the music piece is reproduced from the sound output device by the music piece reproduction device, the operation instruction device determines the operation timing of the operation portion included in a predetermined time range from the current moment on the music piece based on the sequence data, and displays the operation indication mark corresponding to each operation timing determined and the operation reference mark corresponding to the current moment in a state that the operation indication marks and the operation reference mark are positioned along with the temporal axis in the game image. Moreover, the operation instruction device instructs the player the operation timing of the operation portion by making a relative displacement between the operation indication mark and the operation reference mark in accordance with the reproduction progress of the music piece in such a manner as to coincide the operation indication mark and the operation reference mark at the operation timing. The text assignment determination device determines the text which should be assigned to each operation indication mark based on the operation timing in the sequence data and the moment of music piece in the text data. Then, the text output device outputs the text assigned to each operation indication mark in association with the instruction of operation by the operation indication mark. In this way, according to the present invention, the text assignment to each operation instruction mark is determined as following: the sequence data and the text data are prepared as separate data from each other, the sequence data describing the operation timings of the operation portion, and the text data describing the texts each of which is correlated to the moment in music piece. Then, used is information relating to time in both data, that is, the operation timing in the sequence data and the moment of music piece in the text data. Accordingly, in a case that the sequence data with respect to the same music piece is changed, or even if there are plural kinds of sequence data which are different from each other in a difficulty level for the same music piece, it is possible to associate an indication of operation with a text by using the shared text data. Thereby, it is possible to improve the degree of freedom with respect to the association between the indications of operation to the player and the texts.

In one embodiment of the present invention, the text assignment determination device may specify, when any one of the operation timings on the sequence data is set as a specified operation timing, the text to be outputted in a period from the specified operation timing and before a next operation timing based on the moment in music piece correlated to the text in the text data, and determine the text to be assigned to each operation indication mark by correlating the text specified to the operation indication mark corresponding to the specified operation timing. According to this embodiment, even if the same moment in music piece correlated to a text is not specified as the operation timing in the sequence data, the text is correlated to the operation indication mark corresponding to the operation timing which is the closest to and prior to the moment in music piece when the text should be outputted.

In the preset invention, either a display on the game image or a sound output can be employed as the output of text. The association between the instruction of operation timing by the operation indication mark and the output of text may be a case that the output of text is associated in a temporal or positional manner with a display of the operation indication mark, or may be a indirect case that the output of text is associated with the operation of the player which is performed via the instruction of the operation timing by the operation indication mark.

For example, the text output device may output the text associated with the instruction of the operation timing by displaying at least one text assigned to each operation indication mark in the game image in a predetermined positional relation to the operation indication mark corresponding to the at least one text. Moreover, the text output device may display a part of texts assigned to each operation indication mark in the game image in a predetermined positional relation to the operation indication mark, and may display a rest of texts assigned to each operation indication mark in the game image in the predetermined positional relation to the operation indication mark on condition that the player performs an appropriate operation with respect to a coincidence between each operation indication mark and the operation reference mark. According to these embodiments, by the appropriate operation being performed by the player in accordance with the indication of operation by the operation indication mark, all of the texts assigned to the operation indication mark are displayed. Thereby, it is possible to realize by a display control of the texts an element as a game such that the lyrics of music piece are displayed in sequence if the appropriate operation is performed continuingly.

In one embodiment of the present embodiment, the text output device may display all of the texts assigned to each operation indication mark in a predetermined positional relation to each operation indication mark on condition that the player operates the operation portion within a predetermined time range to each operation timing which is instructed by the operation instruction device, and in a case that the condition is not fulfilled, a display of at least one part of all texts to be displayed in the predetermined positional 0 relation may be omitted. Thereby, in a case that fulfilled is the condition that the player operates the operation portion within a predetermined time range to each operation timing instructed by the operation instruction device, all texts assigned to the operation indication mark are displayed. In a case that the condition is not fulfilled, a display of at least one part of all texts to be displayed in the predetermined positional relation is omitted. Because of this, during a state that the player waits for the timing of operation watching the operation instruction, it is possible to improve a visibility of the operation indication mark and the like by omitting the display of one part or all of the texts. On the other hand, when the player performs the operation in such a manner as to match the operation timing, all texts are displayed. Thereby, while suppressing influence to the indication of operation, it is possible to display the indication of operation and the texts of lyrics and the like in a limited space.

In one embodiment of the present invention, the text output device may display, in a case that the condition is not fulfilled, only the text of one character out of the texts assigned to each operation indication mark. Thereby, in a state before the player performs the operation, only a minimum text is displayed. Moreover, the text of one character may be a first positioned text in the texts assigned to each operation indication mark. Thereby, in the texts assigned to each operation indication mark the first text is displayed first. Then, when the player performs the operation at an appropriate moment, in response to the operation, the rest of texts can be displayed.

In one embodiment of the present invention, the text output device may display, in a case that the condition is fulfilled, the text assigned to each operation indication mark at a moment in music piece correlated to the text in the text data. Thereby, when the player performs the operation in such a manner as to match the operation timing, the texts assigned to each operation indication mark are automatically displayed at the moment when those texts should be displayed.

In one positional embodiment of the present invention, the text output device may display the texts in such a manner that at least one part of the texts assigned to each operation indication mark is taken into at least one part of the operation indication mark. According to this embodiment, it is possible to display the operation indication marks and the texts in a limited space in the game image. Moreover, it is possible to make at least a part of the texts function as a part of the operation indication mark. Accordingly, it is possible to reduce the influence which is given by the display of text to the operation indication.

In one embodiment of the present invention, the text output device may output the texts associated with the instruction of operation timing by reproducing from the sound output device all of the texts assigned to each operation indication mark on condition that the player performs an appropriate operation with respect to a coincidence between each operation indication mark and the operation reference mark. Thereby, when the player performs the appropriate operation in accordance with the indication of operation by the operation indication mark, the texts assigned to the operation indication mark are reproduced as sound. Because of this, it is possible to realize by a reproduction control of the texts an element as a game such that the lyrics of music piece are displayed in sequence if the appropriate operation is performed continuingly.

In one embodiment of the present invention, a plurality of operation portions ma be provided to the input device, in the sequence data, the operation timing may be correlated to information for specifying any one of the plurality of operation portions, and the operation instruction device may display the operation indication mark in such a manner that the operation portion corresponding to each operation timing is possible to be discriminated. The operation instruction device may display the operation indication mark and the operation reference mark in such a manner as to be located along with the temporal axis in an operation indication range sectioned for each operation portion in the game image. According to these embodiments, in a case of the input device having plural operation portions, it is possible to display differently from each other the operation timings of the operation portions. Moreover, the operation instruction device may make a relative displacement by moving the operation indication mark toward the operation reference mark.

### Effects of the Invention

As mentioned above, in the present invention, the sequence data describing the operation timing of the operation portion and the text data describing the text correlated to the moment in music piece are prepared as separate data, and, by using information relating to time in both data, that is, the operation timing in the sequence data and the moment in music piece in the text data, an assignment of the texts to each operation indication mark is determined. Thereby, in a case that the sequence data with respect to the same music piece is changed, or even if there are plural kinds of sequence data different from each other in a difficulty level or the like for the same music piece, it is possible to associate each operation indication and each text by using a shared text data. Because of this, it is possible to improve a degree of freedom with respect to an association between the instruction of operation to a player the text.

### BRIEF DESCRIPTION OF DRAWINGS

FIG. 1 A diagram showing an appearance of a game machine according to one aspect of the present invention.

FIG. 2 A functional block diagram of the game machine according to one aspect of the present invention.

FIG. 3 An enlarged diagram of an operation indication image which is displayed as a part of a game image.

FIG. 4 A diagram showing an example of representation of the text which is a change from the representation shown in FIG. 3.

FIG. 5 A diagram showing an example of contents of sequence data.

FIG. 6 A diagram showing an example of an operation sequence portion which is a change from the operation sequence portion shown in FIG. 5.

FIG. 7 A diagram showing an example of lyrics data.

FIG. 8 A diagram showing an example of an assignment of text in the lyrics data to operation timings in the sequence data.

FIG. 9 A flow chart showing a sequence processing routine which is implemented by a game control portion.

FIG. 10 A flow chart showing a operation evaluating routine which is implemented by the game control portion

FIG. 11 A diagram showing a relation between the operation timing and the evaluation range.

### DESCRIPTION OF EMBODIMENTS

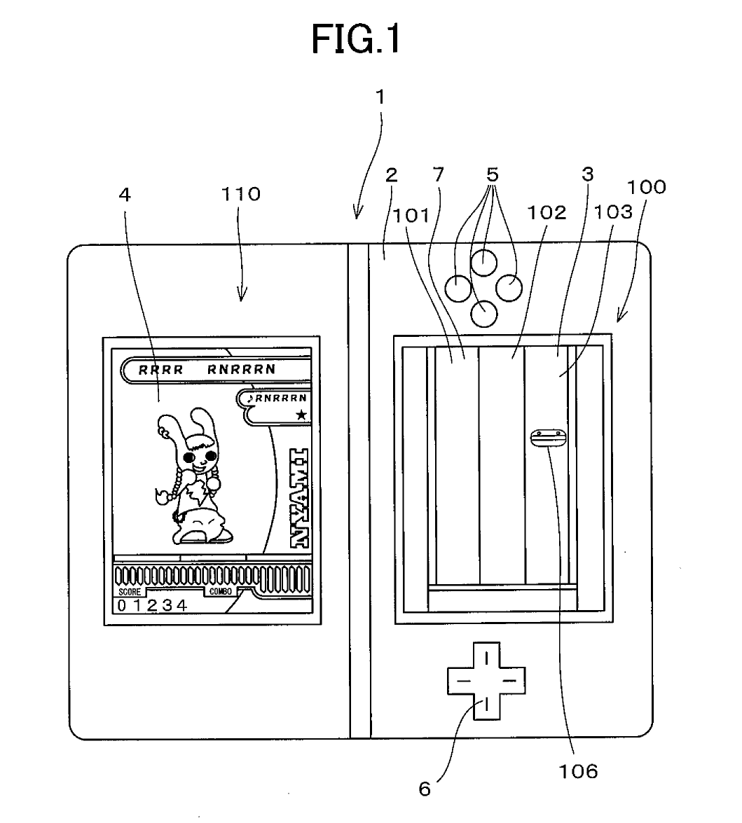

Hereinafter, described are embodiments where the present invention is applied to a portable game machine. As shown in FIG. 1, A game machine 1 has a handheld chassis 2 which a player (a user) can carry about, a first monitor 3 arranged at the right side of the chassis 2, a second monitor 4 arranged at the left side of the chassis 2, a plurality of push button switches 5 arranged at the upper side of the first monitor 3, and a cross-shaped key 6 arranged at the lower side of the first monitor 3. On the surface of the first monitor 3, a transparent touch panel 7 is covered. The touch panel 7 is an input device already known which outputs a signal corresponding to a touched position thereof when being touched by the player with a touch pen or the like. In addition, the game machine 1 is provided with various kinds of input devices and output devices which a general portable-type game machine has, such as a power switch, a volume control switch, a power lump. However, the Illustrations of those devices are omitted in FIG. 1.

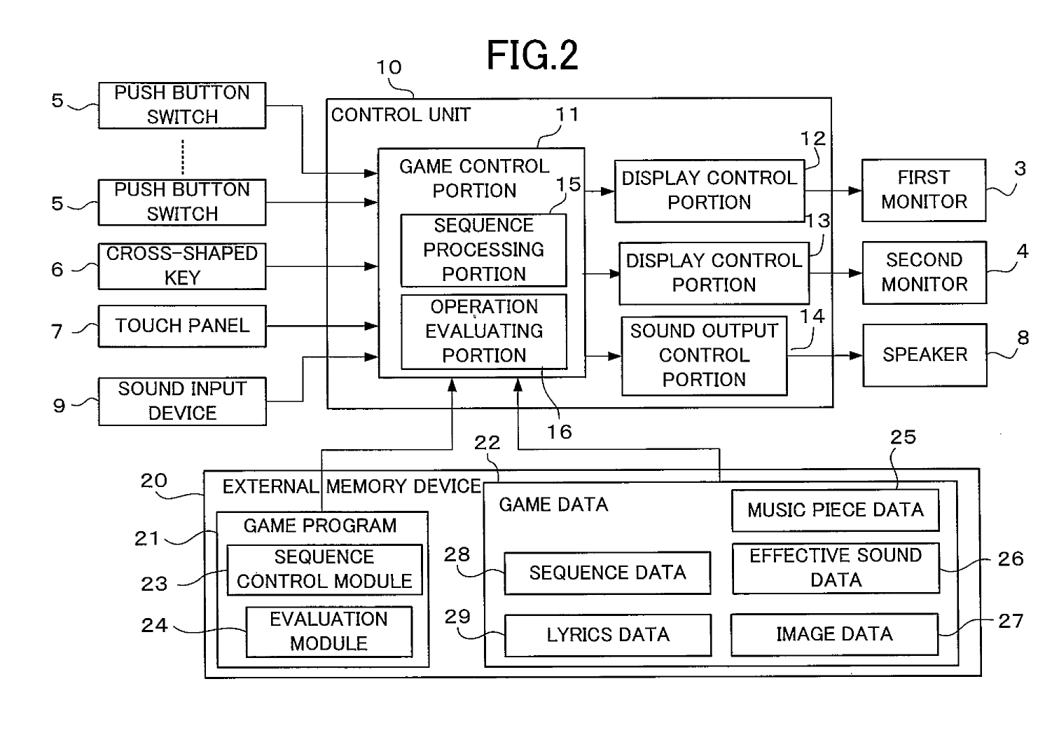

As shown in FIG. 2, in the inside of the portable game machine 1, a control unit 10 as a computer is provided. The control unit 10 comprises a game control portion 11 as a controller, and a pair of display control portions 12, 13 and a sound output control portion 14 which are operated by following the output from the game control portion. The game control unit 11 is configured as a unit obtained by combining a micro processor and various kinds of periphery devices such as internal memory devices (e.g. a ROM and a RAM) which are necessary for the operations of the microprocessor. The display control portions 12, 13 draw on a frame buffer an image according to image data given from the game control portion 11, and outputs video image signals corresponding to the image drawn to the monitors 3, 4 respectively, whereby the display control portions 12, 13 make the monitors 3, 4 display a predetermined image respectively. The sound output control portion 14 generates and outputs to the speaker 8, sound reproduction signals according to the sound reproduction data given from the game control portion 11, whereby the sound output control portion 14 makes the speaker 8 reproduce a predetermined sound (including music sound and the like).

Connected with the game control portion 11 as the input devices are the push button switches 5, the cross-shaped key 6 and the touch panel which have been mentioned above, and a sound input device (a microphone) 9 as well. In addition to those, various kinds of input devices can be connected with the game control portion 11. Further, an external memory device 20 is connected with the game control portion 11. As the external memory device 20, a memory device capable of holding memory without electric supply including a nonvolatile semiconductor memory device, such as EEPROM, a magnetic memory device and the like is employed. The storage medium of the external memory device 20 is capable of attaching and detaching to the game machine 1.

In the external memory device 20, a game program 21 and a game data 22 are stored. The game program 21 is a computer program necessary for implementing a music game in accordance with a predetermined process, and a sequence control module 23 and an evaluation module 24 for realizing functions according to the present invention are included in the game program 21. When the game machine 1 is activated, the game control portion 11 implements various kinds of initial settings necessary for making itself function as the game machine 1 by implementing an operation program stored in the internal memory device. Subsequently, the game control portion 11 sets circumstances for implementing the music game in accordance with the game program 21, by reading from the external memory device 20 and implementing the game program 21. The sequence control module 23 of the game program 21 is implemented by the game control portion 11, whereby a sequence processing portion 15 is generated in the game control portion 11. The evaluation module 24 of the game program 21 is implemented by the game control portion 11, whereby an operation evaluating portion 16 is generated in the game control portion 11. The sequence processing portion 15 and the operation evaluating portion 16 are logical devices which is implemented by a combination of a computer hardware and a computer program. The sequence processing device 15 implements processing for music game in such a way as to indicate operations to a player in accordance with the reproduction of music (a music piece) selected by a player, and output an effective sound in response to an operation by the player. The operation evaluating portion 16 implements processing in such a way as to evaluate the operations by the player and control the game appropriately with the evaluation result. In the game program 21, various kinds of program modules necessary for implementing the music game in addition to the above mentioned modules 23, 24. Although the logical devices corresponding to those modules are also generated, the illustrations are omitted.

Included in the game data 22 is various kinds of data which should be referred at the moment when the music piece data is implemented in accordance with the game program 21. For example, included in the game data 22 are music piece data 25, effective sound data 26 and image data 27. The music piece data 25 is data necessary for outputting a reproduced music piece as an object of the game from the speaker 8. Although one kind of music piece data 25 is shown in FIG. 2, actually, a player can select one music piece out of plural music pieces. In the game data 22, the plural pieces of music piece data are stored in association with information for identifying each music piece. The effective sound data 26 is data in which plural kinds of effective sounds to be outputted from the speaker 8 in response to an operation by a player are stored in such a way that a unique code is correlated with each kind of effective sound. The effective sound includes sounds of instruments as well as various kinds of sounds. A vocal sound for outputting text from the speaker 8 is also included in one kind of effective sound. For each kind of effective sound, a predetermined number of octaves of the effective sound are prepared by changing music pitch of the effective sound. The image data 27 is data for displaying a background image in the game image, various kinds of objects and icons and the like on the monitor 3,4.

In the game data 22, sequence data 28 and lyrics data 29 are further included. The sequence data 28 is data where operations to be indicated to a player and the like are defined. At least one piece of sequence data 28 is prepared for one piece of music piece data 25. The lyrics data 29 is data where lyrics of the music piece is stored in association with time in the music piece. The details of these data 28, 29 will be described later.

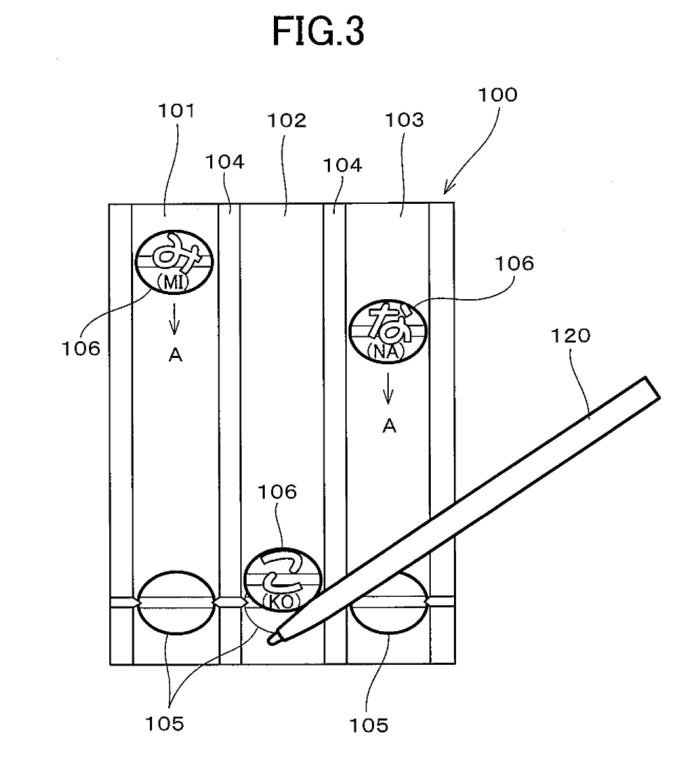

Next, described will be the outline of the music game which is implemented by the game machine 1. As shown in FIG. 1, while the music game being implemented by the game chine, an operation indication image 100 for the game is displayed on the first monitor 3. An information image 110 for the game is displayed on the second monitor 4. As shown in FIG. 3, a first lane 101, a second lane 102, and a third lane 103, each of them extending in a vertical direction, are displayed in the operation indication image 100 in a state of being sectioned by each section line 104 to be visually sectioned. In the bottom end portion of each of the lane 101, the lane 102 and the lane 103, an operation reference mark is displayed. While the music game being ongoing, that is, while the reproduction of music piece progressing, in each of the lane 101, the lane 102, and the lane 103, an object 106 as an operation indication mark is displayed in accordance with the sequence data 28.

The object 106 appears in the top end portion of each of the lane 101, the lane 102, and the lane 103 at a appropriate timing in the music piece, and is scrolled downward in accordance with the progress of the music piece, as shown by an arrow A in FIG. 3. A player is required a touch operation with an operation member such as a touch pen 120, to one of the lanes 101,102,103 where the object 106 is displayed, so as to match the timing when the object 106 reaches the operation reference mark 105. When the player performs the touch operation, detected is a mismatched time between the moment when the object has matched the operation reference mark 105 and the moment when the player has performed the touch operation. As the mismatched time is smaller, the operation by the player is evaluated more highly. In addition, in a response to the touch operation, an effective sound corresponding to each object 106 is reproduced from the speaker 8. In an example of FIG. 3, shown is a state of the moment immediately before the object 106 reaches the operation reference mark 105 in the second lane 102. The player is required to perform the touch operation to the second lane 102 so as to match the moment of reaching the operation reference mark 105. It does not where the position to be touched is, as long as in the second lane 102. Namely, in the present embodiment, three operation portions are formed by combining the lanes 101,102,103 displayed on the first monitor 3 and the touch panel 7 covered thereon. Hereinafter, each of the lanes 101,102,103 is sometimes referred to as a term for representing the operation portions.

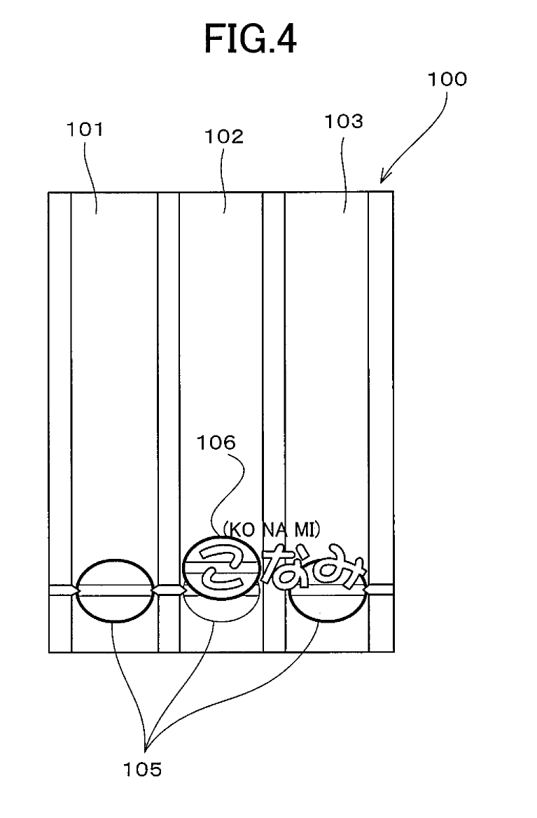

In a case that the music piece selected by a player has its lyrics, at least one text (character(s)) composing the lyrics is assigned to the object 106. At least one of the texts assigned (a first text in the present embodiment) is displayed so as to overlap the object 106. Thereby, the text is taken in as a part of the object 106. Then, when the touch operation is performed so as to match the moment when the object 106 reaches the operation reference mark 105, the text assigned to the object 106 is outputted from the speaker 8 as at least one part of the effective sound. In the example illustrated, “ [symbol] (MI)” is assigned to the object 106 in the first lane 101, “ [symbol] (KO)” is assigned to the object 106 in the second lane 102, and “ [symbol] (NA)” is assigned to the object 106 in the third lane 103. If the second lane is touched at the moment when the object in the second lane 102 reaches the operation reference mark 105, the text “ [symbol] (KO)” are reproduced from the speaker 8 as a vocal sound. In a case that plural texts are assigned to one object 106, when the touch operation is performed, all of the texts assigned to the object 106 are outputted from the speaker 8 as the vocal sound. In addition, as shown in FIG. 4, so as to match the touch operation, all of the texts assigned to the object 106 are displayed. In this case, all of the texts can be displayed at the same time, or each of the texts can be display in the order they should be displayed.

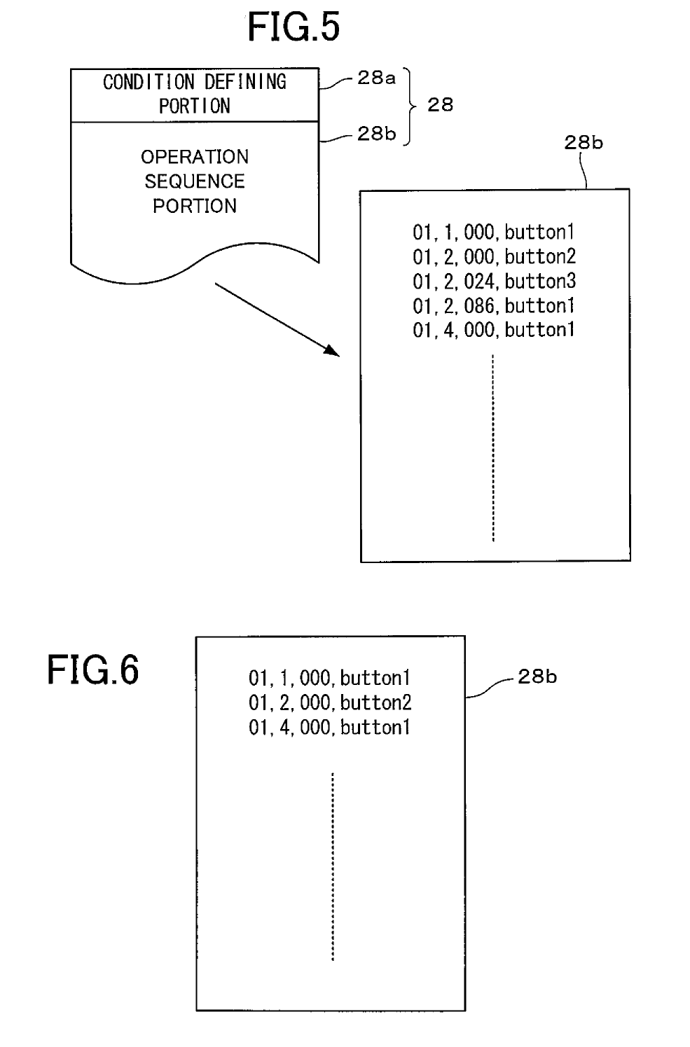

Next, referring to FIGS. 5 to 7, the sequence data 28 and the lyrics data 29 will be described in details. As shown in FIG. 5, the sequence data 28 includes a condition defining portion 28a and an operation sequence portion 28b. In the condition defining portion 28a, described is information specifying conditions for executing the game and the like which is variant for each music piece, such as a tempo of music (e.g. BPM), information specifying effective sound to be outputted at the moment when the operation is performed to each of the lanes 101 to 103, and information specifying a correlation between the mismatch of operation timing and an evaluation.

On the other hand, in the operation sequence portion 28b, the operation timings of the lanes 101 to 103 are described in association with information specifying any one of the lanes 101 to 103. That is, as one part of the operation sequence portion 28b shown in FIG. 5, the operation sequence portion 28b is constructed as a gathering of plural records, and in each record, the timing when to perform the operation during a music piece (the operation timing) and the information specifying the operation portion (the lane) are correlated with each other. The operation timing is constructed by values indicating a bar number, number of beats, and a timing within one beat in a music piece respectively, which are sectioned with a comma. The timing within one beat means an elapsed time from a top of one beat, and is represented as the number of units from the top of the beat when the time length of one beat is divided equally into n pieces of unit time. For example, in a case of n=100, when the operation timing represents the moment when a quarter amount of units from the top of a beat elapses in the second beat of the first bar of a music piece, the operation timing is represented as “01, 2, 023”. The operation portion is represented as the “button 1”, the “button 2” and the “button 3” when specifying the first lane 101, the second lane 102 and the third lane 103 respectively. In the example shown in FIG. 5, the operation timings and the operation portions are specified so that the first lane should be touched at the moment of the start point (000) of the first beat of the first bar, the second lane should be touched at the moment of the start point (000) of the second beat of the first bar, and the third lane 103 should be touched at the moment of “024” unit of time elapsed from the start point of the second beat of the first bar. In FIG. 5, though the condition defining portion 28a is located at only the top of the sequence data 28, the condition defining portion 28a can be located appropriately in the middle of operation sequence portion 28b. Thereby, it is possible to implement, while reproducing a music piece, processes such as a tempo change and a assignment change of effective sounds.

Plural kinds of sequence data 28 which are different in a difficulty level from each other can be prepared for one music piece. For example, by reducing a part of operations from the operation sequence data 28b shown in FIG. 5, the sequence data 28 as shown in FIG. 6 can be obtained. In FIG. 6, the illustration of the condition determination portion 28a is omitted. In the example of FIG. 6, by deleting two of the operation timings “01, 2, 024” and “01, 2, 086” in the operation sequence portion 28b shown in FIG. 5, the number of operations which are required to a player decreases. Thereby, the difficulty level of the game also decreases. In a case that plural kinds of sequence data 28 which are different in the difficulty level for one music piece, the information for discriminating the difficulty level is added to the plural kinds of sequence data 28.

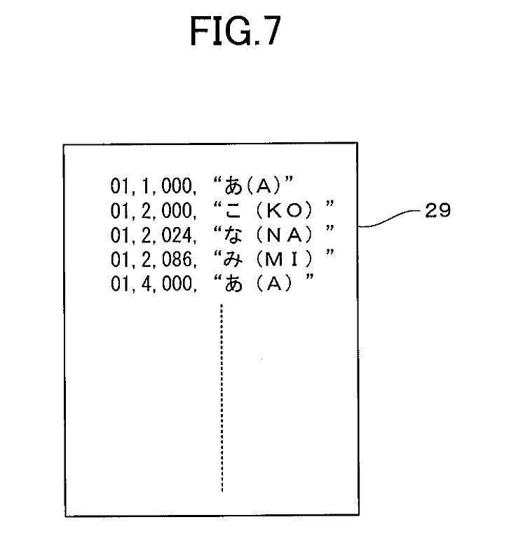

As shown in FIG. 7, the lyrics data 29 is data in which each of the texts constructing the lyrics and the moment in music piece when each of the texts should be outputted are described in association with each other. The moment in music piece is described in the same manner as the operation timing of the operation sequence portion 28b in the sequence data 28. Each text is specified, for example, by using the ASKII code. The moment in the lyrics data 29 is specified by analyzing at which moment in music piece each of the texts of the lyrics should be pronounced. The operation timing specified in the operation sequence portion 28b is coincident with the moment in music piece associated with any one of the texts in the lyrics data 29. However, it is not necessary to specify the operation timings in such a way that the operation timings are correlated to all of the texts included in one music piece respectively one to one.

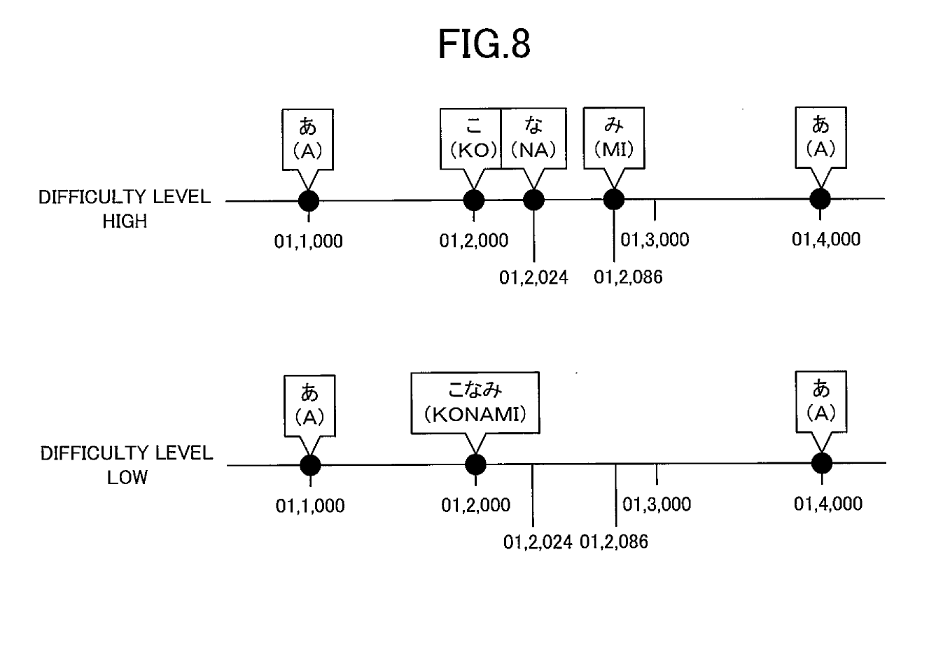

The sequence processing portion 15 of the game control portion 11 controls the display of each of the lanes 101 to 103 so that the object 106 coincides with the operation reference mark 105 at the operation timing specified in the sequence data 28. The sequence processing portion 15 determines an assignment of text to each object 106 by using the operation timing of the sequence data 28 and the moment in music piece of the lyrics data 29, and displays the determined text overlapped on the object 106. As an example of the assignment, FIG. 8 shows a state that each text of lyrics described in the lyrics data 29 shown in FIG. 7 is assigned to the operation timing described in the sequence data 28 shown in FIG. 5 or FIG. 6. “DIFFICULTY LEVEL HIGH” corresponds to the operation sequence portion 28b shown in FIG. 5 and “DIFFICULTY LEVEL LOW” corresponds to the operation sequence portion 28b shown in FIG. 6.

With respect to the relation between the sequence data 28 of “DIFFICULTY LEVEL HIGH” shown in FIG. 5 and the lyrics data 29 shown in FIG. 7, the operation timing and the moment of text is correlated to each other one to one. Therefore, each character of the text is assigned to each object 106, the text being the same in the timing as the object 106. In the mean time, some operations are omitted in the sequence data 28 of “DIFFICULTY LEVEL LOW” shown in FIG. 6. Thereby, with respect to a part of texts in the lyrics data 29, there is no operation of the same timing as those texts. For example, though, “ [symbol] (NA)” is assigned to “01, 2, 024” and “ [symbol] (MI)” is assigned to “01, 2, 086” in the lyrics data 29 shown in FIG. 7, in the operation sequence portion 28b shown in FIG. 6, not specified is the operations of the same timing as those texts. In this case, when one operation timing is set as a specified operation timing, all texts which should be outputted in a period after the specified operation timing and before the next operation timing are assigned to the object 106 corresponding to the specified operation timing. For example, in a case that “01, 2, 000” corresponding to the “text [symbol] (KO)” is set as the specified operation timing, the texts “ [symbol] (NA)” and “ [symbol] (MI)” exiting before the next operation timing !01, 4, 000” are also assigned to the specified operation timing. Thereby, as shown in FIG. 4, it is possible to assign plural texts to a single object 106.

Next, described will be the processing of the game control portion 11 at the moment when the music game is executed in the game machine 1. After ending a primitive setting necessary for reading the game program 21 to execute the music game, the game control portion 11 waits the instruction to start the game from a player. The instruction to start the game includes an operation for specifying data to be used in the game such as an selection of music piece to be played in the game or a selection of difficulty level. The processes to accept those instructions could be similar to the processes in already known music games.

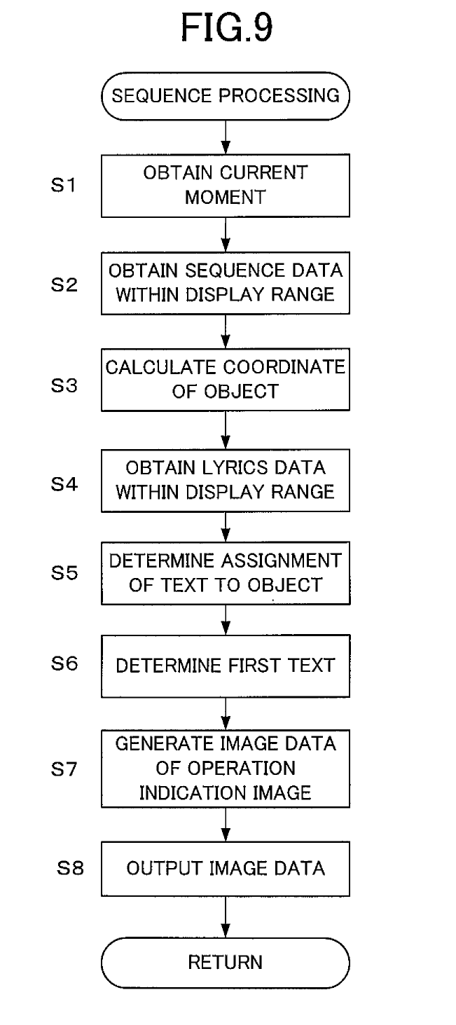

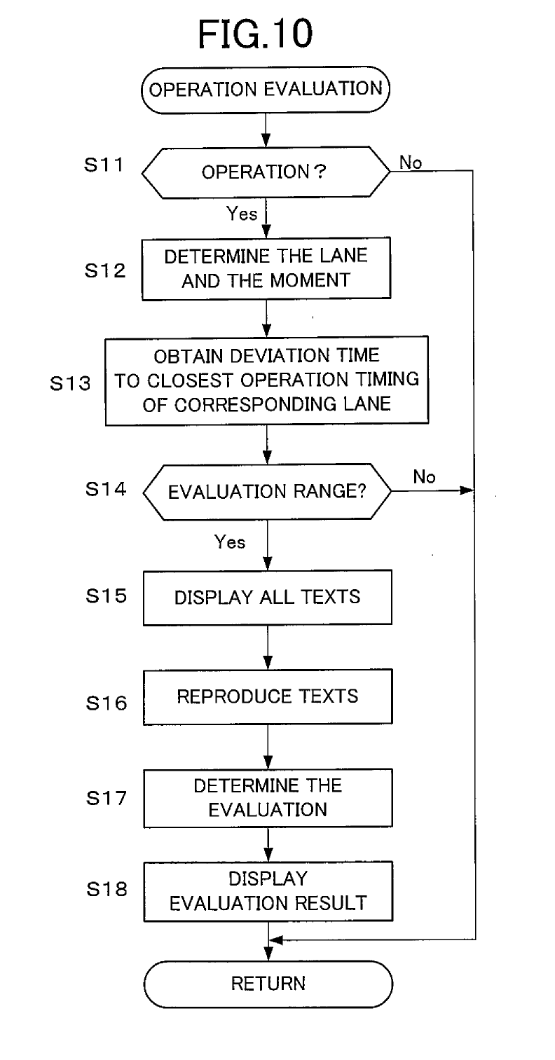

When the game starts, the game control portion 11 makes the sound output control portion 14 start the reproduction of the music piece from the speaker 8 by reading and outputting to the sound output control portion 14 the music piece data 25 corresponding to the music piece selected by the player. Thereby, the control unit 10 functions as a music piece reproduction device. The game control unit 11 reads out the sequence data 28 and the lyrics data 29 corresponding to the selection by the player, and generates and outputs to the display control portion 12 image data necessary for drawing the operation indication image 100 and the information image 110 in reference to the image data 27, in synchronization with the reproduction of the music piece, and thereby, makes the display control portion 12 display the operation indication image 100 and the information image 110 on the monitors 3, 4. Moreover, while implementing the music game, the game control portion 11 implements repeatedly at a predetermined interval each of the sequence processing routine shown in FIG. 9 and the operation evaluating routine shown in FIG. 10, as the processing necessary for displaying the operation indication image 100 and the like. The sequence processing portion 15 and the operation evaluating portion 16 operates the routine shown in FIG. 9 and the routine shown in FIG. 10 respectively.

When the sequence processing routine in FIG. 10 is started, the sequence processing portion 15 of the game control portion 11 firstly, at step S1, obtains the current moment in music piece. For example, by setting a start moment of the reproduction of music piece as a reference moment, an inner clock in the game control portion 11 starts keeping time, and the current moment is obtained from the value of the inner clock. At subsequent step S2, the sequence processing portion 15 obtains, from the sequence data 28, data of the operation timings existing within a time length corresponding to a display range of the operation indication image 100. As an example, the display range is set as the time length of two bars of the music piece from the current moment toward the future.

At the next step S3, the sequence processing portion 15 calculates a coordinate on the operation indication image 100 for all of the objects 106 to be displayed in the lanes 101 to 103. As an example, the calculation is performed as the following. Based on each of the specifications of the lanes 101 to 103, that is, the specification of any one of “button 1” to “button 3” in the example shown in FIG. 5 or FIG. 6, correlated to the operation timing included in the display range, it is determined which of the lanes 101 to 103 the object 106 should be located on. And, in accordance with a temporal difference between the current moment and each operation timing, determined is a position of each object 106 with respect to a temporal axis direction (that is, a moving direction of the object 106) from the operation reference mark 105. Thereby, obtained can be the coordinate of each object 106 necessary for assigning each object 106 along the temporal axis from the operation reference mark 105 in one of the lanes 101 to 103 specified.

When completing the calculation for the coordinate of the object 106, the sequence processing portion 15 progresses to step S4 to obtain a record included in the display range of the lyrics data 29. For example, in a case that the display range is set as the temporal length of two bars, the sequence processing portion 15 obtains the texts of the lyrics included in the range of two bars from the current moment and the moment in music piece correlated to each of the texts obtained. After that, the sequence processing portion 15 progresses to step S5 to determine the assignment of texts to the object 106. As mentioned in reference to FIG. 8, The assignment is performed by using the operation timing and the moment in music piece of each text. Subsequently at step S6, the sequence processing portion 15 determines the first text out of the texts assigned to each object 106. With respect to the object 106 to which the text of only single character is assigned, the text is determined as the first text. With respect to the object 106 to which the text of plural characters is assigned, the first single character is set as the first text.

At the next step S7, the sequence processing portion 15 generates image data necessary for drawing the operation indication image 100 based on the coordinate of the object 106 calculated at step S3, and the first text of each object 106 determined at step S6. Specifically, each object 106 is arranged on the calculated coordinate, and the image data is generated so that the first text is displayed in such a way as to be taken into each object 106. The image of object 106 and the image of the first text may be obtained from the image data 27. With respect to the text, by preparing a font file, the font corresponding to the first text may be incorporated in a part of each object 106.

Subsequently, at step S8, the sequence processing portion 15 outputs the image data to the display control portion 12. Thereby, the operation indication image 100 is displayed on the first monitor 3. After completing the processing of step S8, the sequence processing portion 15 terminates the sequence processing routine of this time. By repeating the above mentioned processing, the object 106 is displayed while scrolling in one of the lanes 101 to 103 so as to reach the operation reference mark 105 at the operation timing described in the sequence data 28.

Next, the operation evaluating routine shown in FIG. 10 will be described. When the operation evaluating routine shown in FIG. 10 starts, the operation evaluating portion 16, first at step S11, refers to output signals of the touch panel 7, and determines whether a touch operation has been performed to the lanes 101 to 103. At this time, in a case that a position other than the lanes 101 to 103 is touched, it is determined that the touch operation has not been performed. In a case that the touch operation has not been performed, the operation evaluating portion 16 terminates the routine of this time. In a case that the touch operation has, the operation evaluating portion 16 progresses to step S12. At step S12, the operation evaluating portion, based on a position signal output form the touch panel 7, determines whether the touch operation has been performed in any one of the lanes 101 to 103, and determines the moment (the moment in music piece) when the touch operation has been performed. Subsequently at step S13, with respect to the lane were the touch operation has been performed (sometimes referred to as “the correlating lane”), the operation evaluating portion 16 specifies a closest operation timing which is described in the sequence data 28, that is, with respect to the lane where the touch operation has been performed, the operation evaluation portion 16 specifies a temporally closest operation timing in the sequence data 28. Then, the operation evaluating portion 16 obtains a deviation time between the operation timing and the moment when the touch operation has been operated.

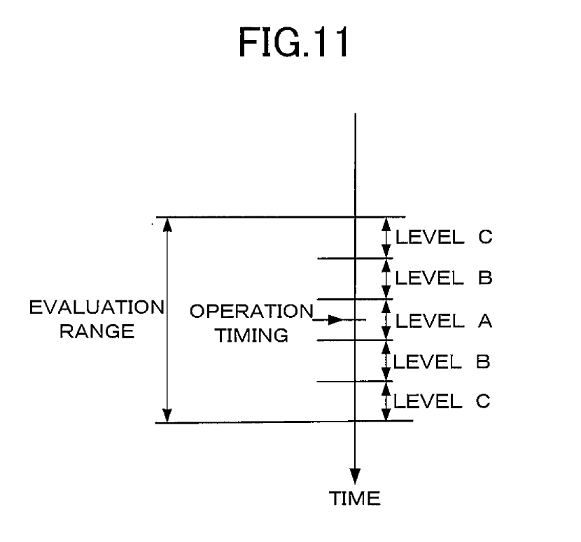

At the next step S14, the operation evaluating portion 16 determines whether the deviation time is within the evaluation range to determine whether the player's operation is appropriate or not. The evaluation range is set as a predetermined time rang before and after the operation timing to be compared as a center. As an example, as shown in FIG. 11, a plurality of levels (the levels A to C in the figure) are set in such a way that the center of the levels is the operation timing, and the time range where those levels are set is treated as the evaluation range. At step S14, in a case that the deviation time is beyond the evaluation range, the operation evaluating portion 16 terminates the routine of this time. In a case that the deviation time is within the evaluation range, the operation evaluating portion 16 progresses to step S15. At step S15, the operation evaluating portion 16, as shown in FIG. 4, displays all of the texts assigned to the object 106 corresponding to the operation timing to be operated, that is, the object 106 closest to the operation reference mark 105 in the lane where the touch operation has been performed (hereinafter, such object 106 is sometimes referred to as the specified object 106). In this case, all of the texts assigned to the specified object 106 may be displayed at a one time, or may be displayed gradually. As the moment in musical piece is correlated to all of the texts in the lyrics data 29, each text may be displayed at the corresponding moment in music piece.

At the next step S16, the operation evaluation portion 16 reproduces all texts assigned to the specified object 106 from the speaker 8. In this case, the output timing of music data to the sound output control portion is controlled so that each text is reproduced at the moment in music piece which is assigned thereto in the lyrics data 29. Thereby, it is possible to reproduce to output correctly the lyrics in synchronization with the reproduction of the music piece. Subsequently, at step S17, the operation evaluating portion 16 determines the evaluation to the touch operation of the player by determining which one of levels A to C shown in FIG. 11 the deviation time obtained at step S13 belongs to. The level A is the best evaluation, and the evaluation gets lower in an order of: the level B and the level C. After that, the operation evaluating portion 16 progresses to step S18 to control the output to the display control portions 12,13 so that the evaluation result is displayed in either at lest one of the operation indication image and the information image 110. After completing the processing of the step S18, the operation evaluation portion 16 terminates the routine of this time.

According to the mentioned operation evaluating routine, when the player touches the corresponding lane so as to coincide with the moment when the object 106 reaches the operation reference mark 105, the deviation time between the touch operation and the operation timing correlated to the specified object 106 in the sequence data 28 is detected, and the player's operation is evaluated based on the deviation time. Then, when the deviation time is within the evaluation range, while all texts assigned to the specified object 106 being displayed, those texts are reproduced from the speaker 8. Accordingly, in a case that the player keeps performing the touch operation of an appropriate timing playing along with the display of each object 106, while being displayed in sequence on the operation indication image 100, the lyrics are reproduced in sequence from the speaker 8.

As mentioned above, in the game machine of the present invention, the sequence data 28 for specifying an operation timing of each operation portion and the lyrics data 29 for specifying the lyrics are prepared independently, the operation timing and the moment in music piece described in the lyrics data 29 are compared with each other, and a text of the lyrics which should be assigned to each object 106 is determined. Accordingly, even though plural pieces of sequence data 28 which are different from each other in the setting of operation timing are prepared, it is possible to associate each object 106 with a text of lyrics by using the shared lyrics data 29. Then, it is possible to change comparatively easily the correlation between the object 106 for indicating an operation timing and the text of lyrics, and it is possible to enhance a degree of freedom of the correlation.

In the above embodiment, the external memory device 20 of the game machine 1 functions as a music-piece data memory device, a sequence data memory device, and a text data memory device. The control unit 10 functions as an operation instruction device by making the sequence processing portion 15 implement the processes of steps S1 to S3, S7 and S8 in FIG. 9, and functions as an text assignment determination device by making the sequence processing portion 15 implement steps S1, S4 and S5. The control unit 10 functions as a text output device by making the sequence processing portion 15 implement steps S6 to S8 in FIG. 9, and the operation evaluating portion 16 implement steps S6 and S7 in FIG. 6 and steps S15 and S16 in FIG. 10.

The present invention is not limited to the above mentioned embodiment, and may be executed in an appropriate embodiment. Hereinafter described will be other embodiments which can be included in the present invention. With respect to the operation instruction device, without moving the operation indication mark, the relative displacement between the operation indication mark and the operation reference mark can be realized by moving the operation reference mark, In this case, the operation indication mark is updated for each predetermined display range (e.g. a time length corresponding to two bars) in a lump, the display of operation reference mark may be controlled in such a way that the operation reference mark moves from its departure position to its arrival position each time the display range is updated. The present invention can be employed even to a case that only a single operation portion is provided. In a case that plural operation portions are provided, as long as displayed can be the operation indication mark by which each operation portion can be discriminated, the operation instruction device can indicate operations differently from an embodiment that the operation indication mark is displayed in each operation indication range sectioned for each operation portion. For example, a symbol is assigned to each of the plural operation portions, the symbols being different from each other, and the operation indication mark corresponding to each of the symbols is changed for each operation portion. Thereby, even if the operation indication marks of all operation portions are arranged in the same operation instruction range, a player can discriminate which one of the operation portions should be operated. The text may be used as all of the operation indication marks.

In the above mentioned embodiment, the first text assigned to each object 106 is displayed in the operation indication image 100, and in a case that the touch operation of a player exists in a predetermined time range (the evaluation range shown in FIG. 11) to the operation timing, all texts assigned to the specified object 106 are displayed in the operation indication image 100 and those texts are sound-outputted from the speaker 8. However, in the present invention, the output of the text can be changed appropriately as long as the output is associated with the instruction of each operation timing by the operation indicating mark. For example, the output of the text can be realized by either one of a display in the operation indication image 100 or a reproduction from the speaker 8. Regardless of player's operations, All texts assigned to each object 106 may be displayed or may be reproduced. Moreover, a display of the first text in an object 106 may be omitted, and only when the player's operation is included in the evaluation range, all texts assigned to each object 106 may be displayed or reproduced. The text is not limited to the lyrics of music piece, and appropriate text may be outputted in association with an instruction of each operation timing.

On the other hand, a text which should be displayed before a player performs the operation in a predetermined time range (the evaluation range in the above embodiment) is not limited to the first text, and an appropriate text assigned to each operation indication mark may be selected. Moreover, a display of all texts may be omitted until the player performs the operation within a predetermined time range, and in a case that the operation is performed in the time range, all texts may be displayed.

The music game system of the present invention is not limited to a game system which is realized in a mobile type game machine. The music game system may be realized in an appropriate embodiment, such as a stationary game machine for home use, a game machine for commercial use which is installed in a commercial facility, and a game system which is realized by using a network. The input device is not limited to the example of using the touch panel, and various kinds of input device, such as a push button, a lever and a trackball, can be employed.

### EXPLANATION OF REFERENCE NUMBER

1 a game machine
3 a first monitor (a display device)
7 a touch panel (an input device)
8 a speaker (a sound outputting device)
10 a control unit (a computer)
12, 13 a game control portion
14 a sound output control portion
15 a sequence processing portion
16 an operation evaluating portion
20 an external memory device (a music piece data memory device, a sequence data
memory device, a text data memory device)
21 a game program
22 game data
25 a music piece data
28 a sequence data
28a a condition defining portion
28b a operation sequence portion
29 lyrics data
100 an operation indication image (a game image)
101a first lane (an operation indication range)
102 a second lane (an operation indication range)
103 a third lane (an operation indication range)
105 an operation reference mark
106 an object (an operation indication mark)

1. A music game system capable of text output comprising:
an input device having at least one operation portion;
a display device which displays a game image;
a sound output device which reproduces a game sound;
a music-piece data memory device which stores music piece data for reproducing a music piece;
a music piece reproduction device which reproduces the music piece from the sound output device based on the music piece data;
a sequence data memory device which stores sequence data where an operation timing of the operation portion during a reproduction of the music piece is described;
an operation instruction device which determines based on the sequence data the operation timing of the operation portion included in a predetermined time range from a current moment in music piece toward a future, and instructs a player an operation of the operation portion by displaying an operation indication mark corresponding to each operation timing determined and an operation reference mark corresponding the current moment in such a manner that the operation indication mark and the operation reference mark are arranged along with a temporal axis in the game image, and making a comparative disposition between the operation reference mark and the operation indication mark according to temporal progress in the music piece so as to coincide the operation indication mark with the operation reference mark at the operation timing to be indicated by the operation indication mark;
a text data memory device which stores, as data different from the sequence data, text data where a text to be outputted according to the music piece is correlated to a moment in music piece;
a text assignment determination device which determines the text which should be assigned to each of the operation indication marks based on each of the operation timings on the sequence data and the moment of music piece corresponding to the text in the text data; and
a text output device which outputs the text assigned by the text assignment determination device in association with an instruction of each operation timing by the operation indication mark.

2. The music game system according to claim 1, wherein
the text assignment determination device specifies, when any one of the operation timings on the sequence data is set as a specified operation timing, the text to be outputted in a period from the specified operation timing and before a next operation timing based on the moment in music piece correlated to the text in the text data, and determines the text to be assigned to each operation indication mark by correlating the text specified to the operation indication mark corresponding to the specified operation timing.

3. The music game system according to claim 1 or 2, wherein
the text output device outputs the text associated with the instruction of the operation timing by displaying at least one text assigned to each operation indication mark in the game image in a predetermined positional relation to the operation indication mark corresponding to the at least one text.

4. The music game system according to claim 3, wherein
the text output device displays a part of texts assigned to each operation indication mark in the game image in a predetermined positional relation to the operation indication mark, and displays a rest of texts assigned to each operation indication mark in the game image in the predetermined positional relation to the operation indication mark on condition that the player performs an appropriate operation with respect to a coincidence between each operation indication mark and the operation reference mark.

5. The music game system according to claim 1 or 2, wherein
the text output device displays all of the texts assigned to each operation indication mark in a predetermined positional relation to each operation indication mark on condition that the player operates the operation portion within a predetermined time range to each operation timing which is instructed by the operation instruction device, and in a case that the condition is not fulfilled, a display of at least one part of all texts to be displayed in the predetermined positional relation is omitted.

6. The music game system according to claim 5, wherein
the text output device displays, in a case that the condition is not fulfilled, only the text of one character out of the texts assigned to each operation indication mark.

7. The music game system according to claim 6, wherein
the text of one character is a first positioned text in the texts assigned to each operation indication mark.

8. The music game system according to claim 5, wherein
the text output device displays, in a case that the condition is fulfilled, the text assigned to each operation indication mark at a moment in music piece correlated to the text in the text data.

9. The music game system according to claim 3, wherein
the text output device displays the texts in such a manner that at least one part of the texts assigned to each operation indication mark is taken into at least one part of the operation indication mark.

10. The music game system according to claim 1, wherein
the text output device outputs the texts associated with the instruction of operation timing by reproducing from the sound output device all of the texts assigned to each operation indication mark on condition that the player performs an appropriate operation with respect to a coincidence between each operation indication mark and the operation reference mark.

11. The music game system according to claim 1, wherein,
a plurality of operation portions are provided to the input device,
in the sequence data, the operation timing is correlated to information for specifying any one of the plurality of operation portions, and
the operation instruction device displays the operation indication mark in such a manner that the operation portion corresponding to each operation timing is possible to be discriminated.

12. The music game system according to claim 11, wherein
the operation instruction device displays the operation indication mark and the operation reference mark in such a manner as to be located along with the temporal axis in an operation indication range sectioned for each operation portion in the game image.

13. The music game system according to claim 1, wherein
the operation instruction device makes a relative displacement by moving the operation indication mark toward the operation reference mark.

14. A computer readable storage medium storing a computer program for a music game system, the music game system comprising
an input device having at least one operation portion;
a display device which displays a game image;
a sound output device which reproduces a game sound;
a music-piece data memory device which stores music piece data for reproducing a music piece;
a music piece reproduction device which reproduces the music piece from the sound output device based on the music piece data;
a sequence data memory device which stores sequence data where an operation timing of the operation portion during a reproduction of the music piece is described; and
a text data memory device which stores, as data different from the sequence data, text data where a text to be outputted according to the music piece is correlated to a moment in music piece; and
the computer program making a computer incorporated in the music game system function as:
an operation instruction device which determines based on the sequence data the operation timing of the operation portion included in a predetermined time range from a current moment in music piece toward a future, and instructs a player an operation of the operation portion by displaying an operation indication mark corresponding to each operation timing determined and an operation reference mark corresponding the current moment in such a manner that the operation indication mark and the operation reference mark are arranged along with a temporal axis in the game image, and making a comparative disposition between the operation reference mark and the operation indication mark according to temporal progress in the music piece so as to coincide the operation indication mark with the operation reference mark at the operation timing to be indicated by the operation indication mark;
a text assignment determination device which determines the text which should be assigned to each of the operation indication marks based on each of the operation timings on the sequence data and the moment of music piece corresponding to the text in the text data; and
a text output device which outputs the text assigned by the text assignment determination device in association with an instruction of each operation timing by the operation indication mark.
